(19) United States
(12) Patent Application Publication
(10) Pub. No.: US 2006/0250993 A1
(43) Pub. Date: Nov. 9, 2006

(54) SIP signal processing system

(75) Inventor: Yong Kyoung Shin, Seoul (KR)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017, US

(73) Assignee: LG Electronics Inc.

(21) Appl. No.: 11/300,825

(22) Filed: Dec. 14, 2005

(30) Foreign Application Priority Data
Dec. 14, 2004 (KR) 10-2004-0105597

(51) Int. Cl. H04Q 11/00

(52) U.S. Cl. 370/261

(57) ABSTRACT

An SIP signal processing system includes: a signal management control module for managing signals by determining whether the signals transmitted/received through an SIP are overlapped; a signal parsing control module for parsing the signals; a memory module storing the signals; and a main control module for assigning an equal priority to the signal management control module and the signal parsing control module and controlling a memory access of the signal management control module and the signal parsing control module.

This application claims the benefit of the Korean Patent Application No. 10-2004-0105597, filed on Dec. 14, 2004, which is hereby incorporated by reference as if fully set forth herein.

### BACKGROUND OF THE INVENTION

1. Field of the Invention

The present invention relates to a system for processing an SIP signal on a user agent.

2. Description of the Related Art

A Push To Talk (PTT)/Push To View (PTV) application service is provided. The PTT/PTV application service is a technology that selects the other party or group that can be communicated and access the selected party or group in a walkie-talkie scheme. The PTT/PTV application service compresses instant message, voice or image and transmits it to the users registered in a group list in real time.

Generally, the PTT/PTV application service is provided on a personal mobile terminal. When the personal mobile terminal previously indicates the other party who will receive a message and a button is pressed, an individual or group communication can be available through a session initiation protocol (SIP) widely used in a Voice on Internet Protocol (VoIP).

The SIP is an application layer control protocol based on a simple text. The SIP sets a connection with the other party while receiving/transmitting a text-format signal. The SIP has a simple call setup and can transmit unique additional information of the other party over a signal.

Using such an SIP, at least one participant can create a session together and provide teleconference, telephone, event notification, instant messaging, and transmission of compressed images via wireless Internet. The SIP is independent of low-level packet protocols (e.g., TCP, UDP, ATM, X.25. etc.).

The PTT/PTV application service is the most attractive among the mobile data services. In the 3GPP (3^{rd} generation partnership project) and 3GPP2, there has been centrally discussed the call setup using the SIP protocol in application services such as IP multimedia subsystem (IMS), image communications and multipoint communication services.

However, regarding the SIP standard text, there is provided no unified standard for an efficient processing structure that transmits/receives test messages through transmission/reception of various signals via a network.

Since all signals of the SIP are in text format, a process of reading each signal and parsing it in each line is required. It takes a predetermined time to transmit a response to an opponent user agent after parsing one signal.

That is, a predetermined time is necessary for processing one transaction.

At this time, a signal can be inputted from other user agent. In this case, a user agent that is processing one transaction may miss signals during that time.

Also, even when the user agent is processing signals in order for the call setup with another user agent, it may often miss a plurality of signals.

Accordingly, in order to continuously provide the PTT/PTV application service, there is a demand for a structure that can efficiently process the incoming SIP signals, regardless of the signal processing.

Meanwhile, since the SIP used in the related art VoIP has a 1:1 connection, the above problem does not exist. However, in the communication connection having a 1:N(≧2) connection such as the PTT/PTV application service, it is important to efficiently process the signals without missing the incoming signals.

### SUMMARY OF THE INVENTION

Accordingly, the present invention is directed to an SIP signal processing system that substantially obviates one or more problems due to limitations and disadvantages of the related art.

An object of the present invention is to provide an SIP signal processing system in an SIP communication with a 1:N connection structure, in which a signal managing function and a parsing function are operated independently. The signal managing function is to manage the signals not to miss incoming signals from other user agents while processing one transaction, and the parsing function is to efficiently process/respond the signals.

Another object of the present invention is to provide an SIP signal processing system in which signals repeatedly received from other user agents while processing one transaction are managed without missing them and the overlapped signals are processed such that only one signal initially received is processed.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided an SIP signal processing system including: a signal management control module for managing signals by determining whether the signals transmitted/received through an SIP are overlapped; a signal parsing control module for parsing the signals; a memory module storing the signals; and a main control module for assigning an equal priority to the signal management control module and the signal parsing control module and controlling a memory access of the signal management control module and the signal parsing control module.

In another aspect of the present invention, there is provided an SIP signal processing system including: a signal management control module for, when a plurality of user agents and an SIP call are connected together, determining whether a call setup signal transmitted/received aperiodically is overlapped, recording the signals in a memory, and managing the recorded signals by pointing the signals; and a signal parsing control module for executing SIP processor at a priority equal to that of the signal management control module, recognizing a form of a signal by reading the signal in a recorded order, and processing the signal by encoding a method selected according to a form of the recognized signal.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram of the components of a mobile terminal to which an SIP signal processing system according to an embodiment of the present invention is applied;

FIG. 2 is a diagram exemplarily illustrating a data format of an SIP signal used in the SIP signal processing system according to the embodiment of the present invention;

FIG. 3 is a block diagram of the components of a memory module in the SIP signal processing system according to an embodiment of the present invention;

FIG. 4 is a block diagram illustrating a data structure when signals from a plurality of SIP user agents are recorded in a list queue in the SIP signal processing system according to an embodiment of the present invention; and

FIG. 5 is a block diagram illustrating a message format of a request method and a response method for processing signals of a list queue in the SIP signal processing system according to an embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

An SIP signal processing system according to an embodiment of the present invention can be applied to all communication terminal system using an SIP protocol. For convenience, the case where the SIP processing system is applied to a mobile terminal will be described as an example.

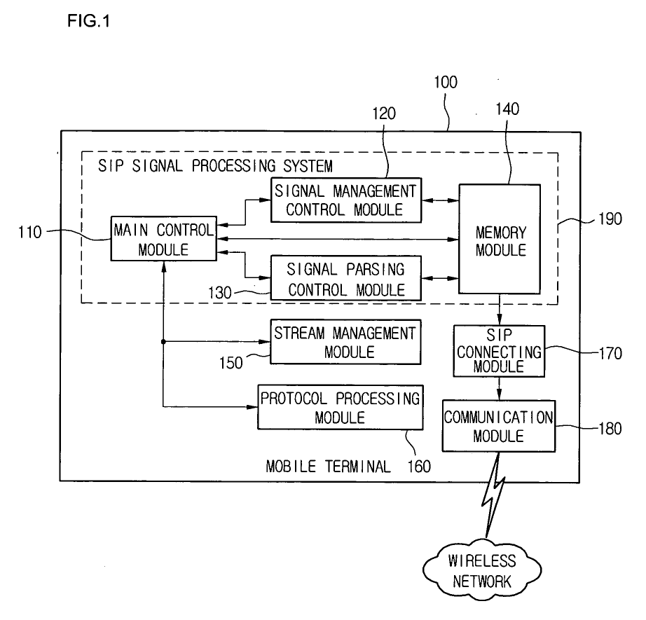

FIG. 1 is a block diagram of the components of a mobile terminal 100 to which an SIP signal processing system 190 according to an embodiment of the present invention is applied.

Referring to FIG. 1, the mobile terminal 100 includes a main control module 110, a signal management control module 120, a signal parsing control module 130, a memory module 140, a stream management module 150, a protocol processing module 160, an SIP connecting module 170, and a communication module 180.

The mobile terminal 100 is connected to a plurality of other user agents (hereinafter, referred to as “other mobile terminals”) via a wireless network and executes a PTT/PTV service communication with the other mobile terminals through the SIP protocol.

In order for the PTT/PTV service communication between the mobile terminals, a process of registering information in a server and a process of receiving the other party's ID and address in a group list are required. Before the processes, a call (a process of checking a standby state in which the contents can be transmitted/received) has to be set.

The communication module 180 and the SIP connecting module 170 receive the call setup signal. The call setup signal is used to determine whether a mobile terminal requests the call setup or responds to the call setup request.

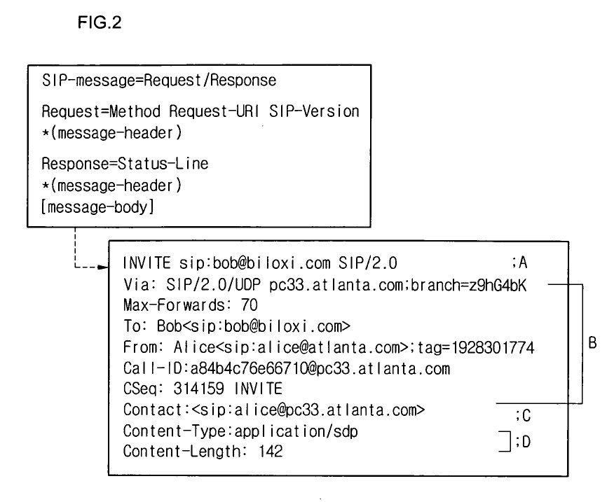

FIG. 2 is a diagram exemplarily illustrating a data format of the SIP signal used in the SIP signal processing system according to the embodiment of the present invention.

Referring to FIG. 2, the SIP signal is divided into message header fields B, C and D and a method field A. The method field A is a start line and has a unique SIP URI (address) information of the mobile terminal.

The message header field may include a general header B constructed with a Cseq number, a call ID, a path (via/from/to) information, and an encryption information, a request header C, and an object header (which represents the kind and size of contents).

A message (data) body including a CRLF (not shown), which is a character representing a line feed and distinguishes an end of the header and a start of the data, and a session description protocol (SDP) (not shown) can be positioned.

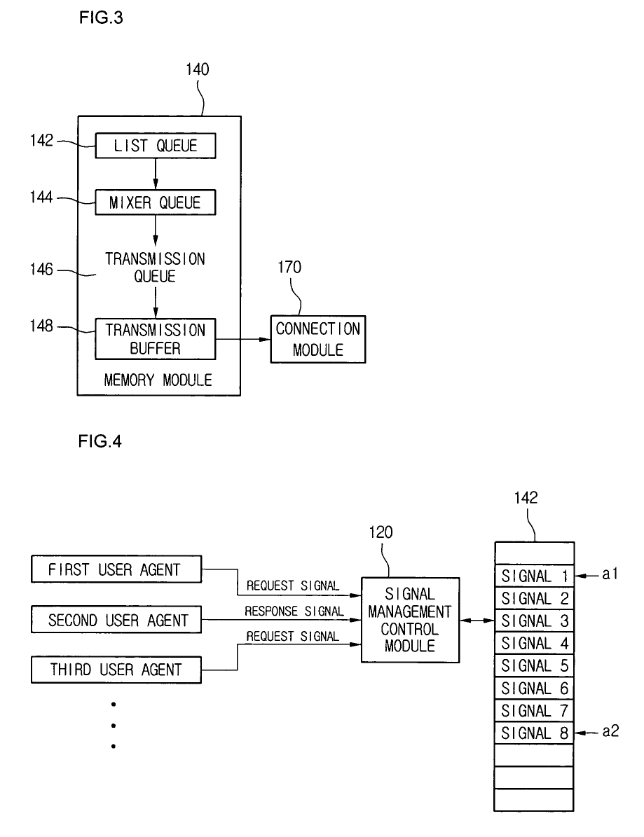

FIG. 3 is a block diagram of the components of the memory module 140 in the SIP signal processing system 190 according to an embodiment of the present invention.

Referring to FIG. 3, the memory module 140 is a storage unit having a data document structure of the queue and includes a list queue 142, a mixer queue 144, a transmission queue 146, and a transmission buffer 148.

The queue has a first-in first-out (FIFO) structure.

The list queue 142 stores the signal. The list queue 142 has a ranked list document structure and is controlled by the signal management control module 120 and the signal parsing control module 130. The list queue 142 has to push and get a plurality of signals. Therefore, the list queue 142 has a small-sized listed document structure so that it can be linked with a message body.

The mixer queue 144 allocates a plurality of spaces according to the number of signals recorded in the list queue 142. Then, the mixer queue 144 stores a series of stream files (e.g., instant message, voice, or compressed image files) and provides a kernel information associated with the storage space allocation.

The transmission queue 146 stores a control information for transmitting the stream files stored in the mixer queue 144 to the transmission buffer 148. The transmission buffer 148 stores the stream files in a stream packet so that they can be transmitted through the SIP connecting module 170 and the communication module 180 without any interrupt.

Referring to FIG. 1, the main control module 110 assigns the equal priority to the signal management control module 120 and the signal parsing control module 130 and makes the SIP processors operate. Also, the main control module 110 controls a memory access of the signal management control module 120 and the signal parsing control module 130.

Also, the main control module 110 collects the transmission request of other user agents (e.g., other mobile terminals) and sets the kernel session. Also, the main control module 110 processes the interrupt for the SIP communication and manages the session through a dynamic scheduling.

If a plurality of call setup signals transmitted/received aperiodically are transmitted through the SIP connecting module 170 and the communication module 180, the signal management control module 120 determines whether or not the signals are overlapped, and then records them in the list queue 142.

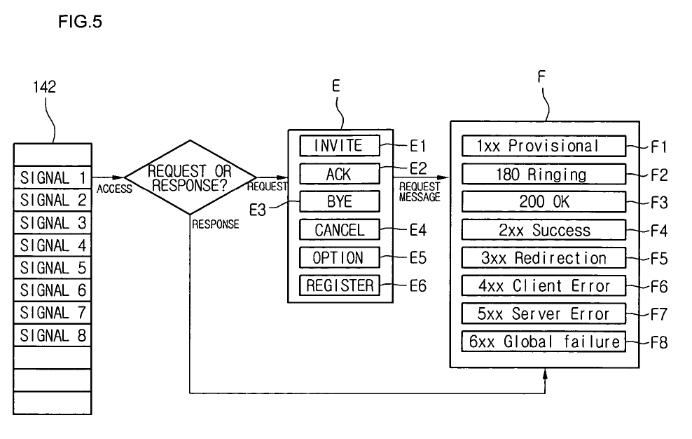

FIG. 4 is a block diagram illustrating a data structure when signals from a plurality of SIP user agents are recorded in the list queue 142 in the SIP signal processing system according to an embodiment of the present invention.

The reason why the signal management control module 120 determines whether the signal are overlapped is that the overlapped signals cannot be stored when the process in the signal parsing control module 130 is delayed.

That is, in the SP signal processing system 190 according to the embodiment of the present invention, the signal management control module 120 receives a lot of signals from a plurality of mobile terminals and manages the signals through the list queue 142 so as not to miss the call.

However, in some cases, the process in the signal parsing control module 130 may be delayed. At this time, since other mobile terminals transmit several times the signals for the call setup, there is a strong probability that the overlapped signals are stored in the list queue 142.

The signal management control module 120 manages the recorded signals by pointing a first signal a1 and a last signal a2 recorded in the list queue 142. The process of determining whether or not the signals are overlapped is as follows.

The signal management control module 120 reads only the first line of the method field except the message header field of the pointed first signal a1 and recognizes the first signal a1. Since the unique SIP URI of the opponent mobile terminal is contained, the signal management control module 120 can determine whether the signals are identical to one another by comparing only the method fields.

If the first signal a1 is recognized, the method field of the signal located in a next queue is read while the signal management control module 120 increments the pointer step by step, and then compares it with the method field of the first signal a1.

In this manner, if a certain signal is determined as being identical to the first signal a1, the signal management control module 120 deletes the latter signal determined as being identical to the first signal a1 from the memory.

On the contrary, if a certain signal is determined as being different from the first signal a1, the signal management control module 120 terminates the process of determining whether or not the signals are overlapped by comparing the method fields of a series of signals.

Through the above processes, the signal parsing control module 130 can parse only the signal initially received.

In storing the signals in the list queue 142, the signal management control module 120 records the signals in the memory, without determining which mobile terminal sends the signals or whether or not the signals are the response with respect to the signals that the signal management control module 120 itself transmits.

Also, in storing the signals in the list queue 142, the signal management control module 120 does not limit the list size of the linked list document structure.

Under control of the main control module 110, the signal parsing control module 130 has the priority equal to that of the signal management control module 120 and independently executes the SIP processor. The signal parsing control module 130 reads the signals and recognizes the form of the signal in the order recorded in the list queue 142.

FIG. 5 is a block diagram illustrating a message format of the request method and the response method for processing the signals of the list queue in the SIP signal processing system according to an embodiment of the present invention.

Referring to FIG. 5, the form of the signal processed by the signal parsing control module 130 includes a request signal E and a response signal F. The request signal E has six method forms: “INVITE(E1)”, “ACK(E2)”, “BYE(E3)”, “CANCEL(E4)”, “OPTION(E5)”, and “REGISTER(E6)”.

The response signal F with respect to the request signal E has following method forms: “1xx Provisional(F1)”, “180 Ringing(F2)”, “200OK(F3)”, “2xx Success(F4)”, “3xx Redirection(F5)”, “4xx Client Error(F6)”, “5xx Server Error(F7)”, and “6xx Global Failure(F8)”.

The signal parsing control module 130 processes the signals by encoding the corresponding method according to the recognized form. For example, if the INVITE method is received from other mobile terminal for the purpose of the call setup, the signal parsing control module 130 encodes one method among the response signals so as to transmit the corresponding response.

At this time, the response method is determined according to the message header having the received INVITE method, and the encoding size and the processing time are different according to the kinds of the response method to be transmitted. Accordingly, assuming that the response processing procedure with respect to one signal is one transaction, the 1:N SIP user agent connection structure has to process a very large number of transactions. Also, an amount of processing of each transaction to be processed in the signal parsing control module 130 is flexible, and therefore the signal parsing control module 130 does not set a time clock in processing the signals.

The signal parsing operation of the signal parsing control module will be described as an example. The signal parsing control module 130 parses the signal and determines whether the signal is the request signal or the response signal. If the signal is the response signal, the form of the response signal is again parsed. If the signal corresponds to “INVITE”, “BYE”, “CANCEL”, or “OPTION” among the six methods, the signal parsing control module 130 parses the message header, processes the corresponding request method, and then transmits it. When the signal is “ACK”, the call setup is recognized as being normally processed.

Since “REGISTER” cannot be processed in the signal parsing control module 130, “5xx Server Error response” is transmitted.

When the user agent is initialized, the main control module 110 generates the list queue 142 of the memory. This queue generating function can be executed in the signal management control module 120 or the signal parsing control module 130.

The SIP connecting module 170 sets the communication channel and transmits/receives test, voice, or picture message in real time. At this time, a login function, a function of registering a user, and a function of registering a user agent (e.g., other mobile terminal) are provided based a P2P file transfer technology.

The communication module 180 includes a transceiver, a duplexer, an antenna, a gain control system, and a time/frequency system, and processes a modulation/demodulation of a code division multiple access (CDMA) radio signal, a channel coding/decoding function, and a transmission/reception of radio signal.

When the communication channel is set by the SIP connecting module 170, the communication module 180 transmits/receives SIP messages such as an SIP call setup signal.

The stream management module 150 receives multimedia data through communication with an SIP server (not shown) or other mobile terminals. At this time, the stream management module 150 adjusts the transmission rate while maintaining isochronisms of the stream data between the memory module 140 and the SIP server or other mobile terminal.

Also, the stream management module 150 manages communication channel information, operation information of the transmission rate, stream status information, and file information.

The protocol processing module 160 analyzes the packet protocol and the communication protocol that processes communication between the user agents, data flow control and load balance.

It will be apparent to those skilled in the art that various modifications and variations can be made in the present invention. Thus, it is intended that the present invention covers the modifications and variations of this invention provided they come within the scope of the appended claims and their equivalent.

What is claimed is:

1. A session initiation protocol (SIP) signal processing system comprising:
a signal management control module for managing signals by determining whether the signals transmitted/received through an SIP are overlapped; and
a signal parsing control module for parsing the signals.

2. The SIP signal processing system according to claim 1, further comprising a memory module storing the signals.

3. The SIP signal processing system according to claim 1, further comprising a main control module for assigning an equal priority to the signal management control module and the signal parsing control module and controlling a memory access of the signal management control module and the signal parsing control module.

4. The SIP signal processing system according to claim 1, wherein the signal management control module determines whether or not the signals are overlapped by comparing method fields of the signals.

5. The SIP signal processing system according to claim 1, wherein when the signals are overlapped, the signal management control module deletes a latter signal.

6. The SIP signal processing system according to claim 1, wherein the signal parsing control module encodes a method selected by parsing a request signal and a response signal.

7. A session initiation protocol (SIP) signal processing system comprising:
a signal management control module for managing signals by determining whether or not incoming SIP signals are overlapped;
a signal parsing control module for parsing the signals;
a memory module storing the signals; and
a main control module for controlling memory access of the signal management control module and the signal parsing control module.

8. The SIP signal processing system according to claim 7, wherein the SIP signal has a message header field and a method field; the method field contains an SIP URI information of a user agent; and the message header field contains a general header constructed with at least one of a Cseq number, a call ID, a path information, and an encryption information, a request header, and an object header indicating kind and size of contents.

9. The SIP signal processing system according to claim 7, wherein the memory module includes a list queue having a linked list document structure, a mixer queue storing a stream file according to the signal recorded in the list queue, a transmission queue storing a control information for transmitting the stream file stored in the mixer queue, and a transmission buffer storing the stream file in a stream packet and transmitting the stream files.

10. The SIP signal processing system according to claim 9, wherein the signal management control module determines whether the signals are overlapped by comparing method fields of the signals recorded in the list queue.

11. The SIP signal processing system according to claim 10, wherein the signal management control module records the signal in the list queue without determining whether the signal is a request signal or a response signal.

12. The SIP signal processing system according to claim 10, wherein the signal is constructed in a request signal form and a response signal form; the request signal has six method forms: INVITE, ACK, BYE, CANCEL, OPTION, and REGISTER; and the response signal with respect to the request signal has eight method forms: 1xx Provisional, 180 Ringing, 200OK, 2xx Success, 3xx Redirection, 4xx Client Error, 5xx Server Error, and 6xx Global Failure.

13. The SIP signal processing system according to claim 7, wherein the memory module has a queue structure.

14. The SIP signal processing system according to claim 7, wherein the main control module assigns an equal priority to the signal management control module and the signal parsing control module.

15. A session initiation protocol (SIP) signal processing system comprising:
a signal management control module for, when a plurality of user agents and an SIP call are connected together, determining whether a call setup signal transmitted/received aperiodically is overlapped, recording the signals in a memory, and managing the recorded signals by pointing the signals; and
a signal parsing control module for executing SIP processor at a priority equal to that of the signal management control module, recognizing a form of a signal by reading the signal in a recorded order, and processing the signal by encoding a method selected according to a form of the recognized signal.

16. The SIP signal processing system according to claim 15, wherein the signal management control module records the signal in the memory without determining whether the signal is a request signal or a response signal.
